(19) United States
(12) Patent Application Publication
(10) Pub. No.: US 2011/0105099 A1
(43) Pub. Date: May 5, 2011

(54) ANTENNA LINE DEVICE CONFIGURATION SYSTEM

(76) Inventor: Ashley James Roll, Queensland (AU)

(21) Appl. No.: 12/935,057

(22) PCT Filed: Mar. 31, 2009
(86) PCT No.: PCT/AU2009/000389

§ 371 Date: Dec. 17, 2010

(30) Foreign Application Priority Data
Apr. 4, 2008 (AU) 2008901615

(51) Int. Cl. H04M 3/00

(52) U.S. Cl. 455/418

(57) ABSTRACT

A communications device comprising firmware, storing instructions for controlling a processor to operate communications hardware according to a configuration; memory storage containing static data and at least one set of dynamic data defining the configuration, the dynamic data being dynamically upgradeable to change the configuration of the communications device substantially in real time.

The present invention relates to a system for configuring Communications Equipment used in the Mobile Phone Industry. In particular, the invention relates to configuring Antenna Line Devices commonly found in mobile phone base stations.

### BACKGROUND TO THE INVENTION

The popularity of mobile phones has soared over the past few decades due to the increasing affordability of owning a mobile phone. In 2007 the number of mobile phone users worldwide was in excess of 2.3 billion and the numbers of base stations at three million and rising.

The base station facilitates wireless communication between a mobile phone and a network. Each base station, in its simplified form, consists of a transceiver and an antenna connected by a feeder. The antenna radiates electromagnetic energy to an area surrounding the antenna, where the electromagnetic energy (signal) is received by a mobile phone handset transceiver. The base station antenna also receives signals from the handset, passing the signals through a receive path of the base station back to the base station transceiver where the signal is routed via a mobile carrier network to a called party. The typical output power from a mobile phone base station transmitter is 25 watts, while the power output from the handset is, however, a maximum of 2 watts. Due to the small amount of received power at the base station antenna an amplifier may be required to boost the signal and to this effect a Tower Mounted Amplifier (TMA) is used. Devices connected in the receive path are collectively known as Antenna Line Devices (ALDs) and may include Remote Electrical Tilt (RET) antennas, signal boosters and Voltage Standing Wave Ratio (VSWR) measuring units.

The TMA is placed in the feeder to the antenna and amplifies the received signal from the handset. It is placed as near to the antenna as possible so that the losses in the feeder are less critical by amplifying the signal before it is lost in the noise floor of the system. Due to the location of the TMA, at the top of a tower or rooftop, any modifications or repairs are time consuming and costly. Access to the TMA involves either climbing the tower, or gaining access to the rooftop and both can be problematic. Some towers are in excess of 50 m high and require two technicians to attend site for safety reasons. Furthermore, the location of the TMA near to the antenna may mean an outage is required to avoid over exposure to electromagnetic fields. Outage times to a carrier mean lost revenue, and hence base stations are rarely powered down.

Some ALDs can be reconfigured remotely, to a very limited extent, by sending commands using a common protocol called AISG (Antenna Interface Standards Group) thus avoiding a site visit. The Antenna Interface Standards Group has created open specifications for the control interface of antenna line products with digital remote control and monitoring facilities. Future developments of the specification are expected to extend the range of devices and the available command syntax. The AISG standard is now incorporated into the 3rd Generation Partnership Project (3GPP) standard. Thus any reference made to the AISG specification also refers to the 3GPP standard (TS 25.460 to TS 25.466) or any future version of these standards.

The advent of the AISG protocol, allows a single command set to be used to control ALDs from a variety of different manufacturers. The AISG communication and control protocol has been designed to control a limited number of essential parameters. For example commands for a TMA are “Get Gain”, “Set Gain”, “Get Mode” and “Set Mode”. Any other changes often require the TMA to be removed and a new one installed or a complete firmware upgrade to be performed. Firmware upgrades are a lengthy and labour intensive process and may result in the loss of service and hence revenue.

It is common practice to configure ALDs at the factory to produce different models. This is because some designs of base station require different hardware configurations outside the control of AISG commands. Some of the following configuration parameters often require changes:

1) Normal operation current consumption settings.

2) Alarm mode current consumption settings.

3) Power supply voltages and the ports the voltages are present on.

4) AISG signaling port configuration.

5) Sequential amplifier power up avoiding a high inrush current.

6) AISG or 3GPP Protocol version or compatibility mode switching.

In order to facilitate the requirements of each configuration, the ALD manufacturer needs to keep and track the different firmware versions created for each customer. Each version of firmware requires debugging and validation before being released to the customer. For the manufacturer, this can mean many different code releases, depending on the customer requirements and the version of the firmware being used. The customer may need to stock many different versions of ALD each with different firmware in order to support a mobile network. Although configuration changes can be made remotely by upgrading the firmware, these uploads are cumbersome, typically taking in the order of five to ten minutes to perform. Although this may not appear to be a long time, when potentially thousands of sites need to be changed, this may mean a collective downtime of many days.

There is therefore a need for an improved Antenna Line Device (ALD) to reduce the spares inventory and to provide a more efficient process for upgrading and maintaining ALDs.

### OBJECT OF THE INVENTION

It is an object of the present invention to overcome and/or alleviate one or more of the above disadvantages or provide the customer with a useful and/or commercial device.

### SUMMARY OF THE INVENTION

In one form, although not necessarily the only or the broadest form, the invention resides in a communications device comprising:

firmware storing instructions for controlling a processor to operate communications hardware according to a configuration;

memory storage containing static data and at least one set of dynamic data defining the configuration, the dynamic data being dynamically upgradeable to change the configuration of the communications device substantially in real time.

Optionally, the dynamic data defines a subset of the configuration.

In another form, although again not necessarily the broadest form, the invention resides in a method for configuring a communications device comprising firmware storing instructions for controlling a processor to operate communications hardware and memory storage containing static data and at least one set of dynamic data defining the configuration; the method including steps of:

creating dynamic data at a host computer; and

transmitting the dynamic data from the host computer to the communications device via a communications interface substantially in real time.

In another form, although again not necessarily the broadest form, the invention resides in a method of configuring a communication device of the type comprising firmware storing instructions for controlling a processor to operate communications hardware to a configuration and memory storage containing static data and at least one set of dynamic data defining the configuration; the method including the steps of:

receiving dynamic data via a communication interface;

writing the dynamic data to an inactive area of the memory storage in the communication device; and
selecting the dynamic data as active data.

Suitably there may be more than one set of dynamic data selectable by the processor. The set of the dynamic data selected by the processor is the active dynamic data.

The dynamic data may be upgraded dynamic data or newly created dynamic data.

The instructions stored in the firmware are suitably configured to cause the communications device to:
receive upgraded dynamic data via a communication interface;
write the upgraded dynamic data to an inactive area of the memory storage; and
select the upgraded dynamic data as active dynamic data.

Suitably the static data and dynamic data are stored in non-volatile memory.

Preferably, the communications device is an antenna line device.

The dynamic data may set failure modes and a communications channel, and the dynamic data may configure hardware to bypass the communications device.

Optionally, the dynamic data sets alarm thresholds.

The dynamic data may be transmitted to the communications device using a Radio Frequency or an RS485 connection and a communications protocol may be used to transmit the dynamic data may be an AISG protocol.

Optionally, the dynamic data selects the version of the communications protocol to be used.

Preferably, the dynamic data contains a header.

The communications device may be defined in the Antenna Interface Standards Group (AISG)/3rd Generation Partnership Project (3GPP) standard and the dynamic data may configure the hardware to initialise in stages.

### BRIEF DESCRIPTION OF THE DRAWINGS

FIG. 1 is block diagram of an antenna line device configuration according to an embodiment of the present invention.

FIG. 2 is a flow diagram showing the upload process to an Antenna Line Device.

FIG. 3 is a screen shot of the client application software.

FIG. 4 is a screen shot of the client application software showing the mode selection drop-down box.

### DETAILED DESCRIPTION OF THE PREFERRED EMBODIMENT

The present invention relates to a system for remotely configuring communication equipment in particular Antenna Line Devices (ALDs) 20 found at mobile phone base stations. The system can create, modify and transmit dynamic data 24b to the ALD. The dynamic data 24b permits a technician to quickly and efficiently change a configuration of the ALD 20. The dynamic data 24b sets configurations or modes that can be selected to place the ALD in a particular operating state. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

Throughout this patent specification reference is made to the Antenna Interface Standards Group (AISG) specifications. The AISG standard is also fully included into the 3rd Generation Partnership Project (3GPP) standard (TS 25.460 to TS 25.466), the functionality being similar to AISG 2.0. Any mention made to the AISG specification is taken to also mean the 3GPP standard (TS 25.460 to TS 25.466) or any future version of these standards.

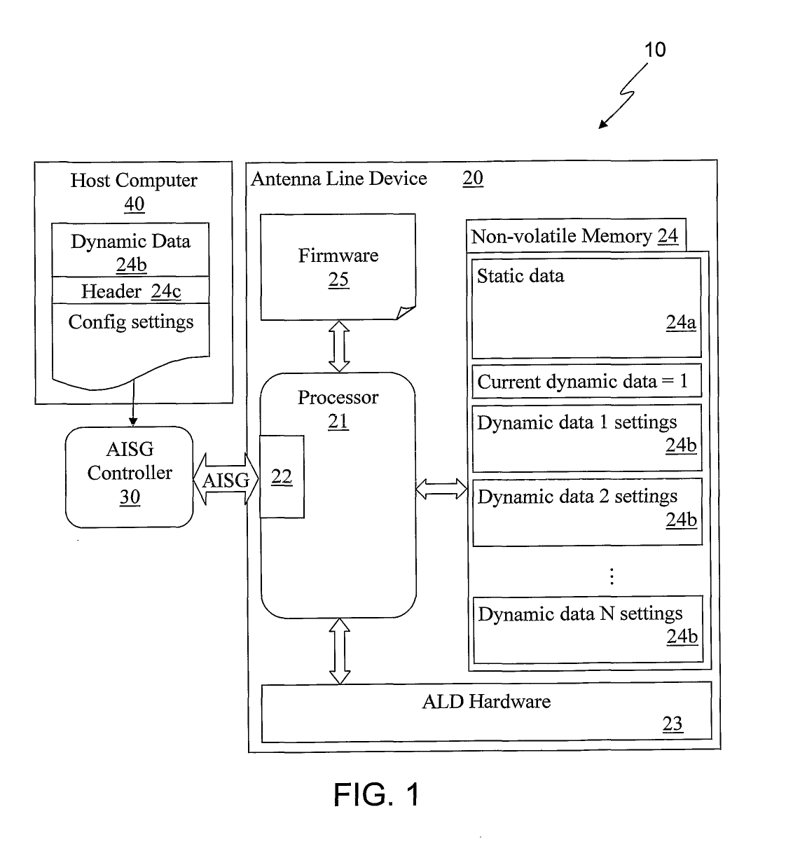

One embodiment of the present invention is described below with reference to FIGS. 1, 2, 3 and 4.

FIG. 1 is a block diagram of an antenna line device configuration system 10 that uploads the dynamic data 24b to the Antenna Line Device 20 (ALD). ALD 20 is a general term that covers all devices used in the communications industry used to analyse or modify the performance of a mobile base station. Some examples include Remote Electrical Tilt (RET) antennas, amplifiers and VSWR analysers. Although the present invention is described around Antenna Line Devices 20, it is envisaged that the present invention can be applied to other devices used in the communications industry or any other devices defined in the AISG/3GPP (TS 25.460 to TS 25.466) standard as would be obvious to a person skilled in the art.

The ALD 20 comprises a processor 21, a communication interface 22, a memory storage in the form of non-volatile memory 24, interfaced by a bus (not shown). Processor 21 may directly or indirectly control ALD hardware 23. The non-volatile memory 24 contains configuration data comprising static data 24a and dynamic data 24b. The processor 21, communication interface 22, bus and non-volatile memory 24 may be a single chip as is well known to a person skilled in the art. Furthermore the non-volatile memory 24 may be located in the ALD processor 21 or using external components. Non-volatile memory 24 may also contain the firmware 25 that controls the basic functions of the ALD 20 or the firmware 25 may be located in a separate component as would be obvious to a person skilled in the art. Additionally it should be appreciated that processor 21 may also use volatile memory as would be known to a person skilled in the art.

Static data 24a are only modifiable by the manufacturer using AISG vendor commands or similar methods. An example of static data 24a is the device serial number which must remain unique.

Dynamic data 24b define a configuration of the ALD 20 specific to an installation or base station. This allows the ALD 20 to be reconfigured without modifying the firmware 25. Similarly, the firmware 25 may be uploaded without erasing the dynamic data 24b.

In the preferred embodiment of the present invention the communication interface 22 is a Radio Frequency (RF) interface. In addition to providing a Radio Frequency path the RF interface also acts as the ALD's Direct Current (DC) power source and the ALD's communication interface as is known to a person of ordinary skill in the art. A communications protocol used on the Radio Frequency interface is AISG and communicates with a controller 30 which in the present embodiment is AISG compliant. AISG is an acronym for Antenna Interface Standards Group. The group whose members include ALD manufacturers, have created open specifications for the control interface of antenna line products with digital remote control and monitoring facilities. AISG commands can only modify a basic set of parameters and cannot change the configuration of the ALD 20.

A host computer 40 is in communication with the memory storage including computer program instructions in the form of a Dynamic Data Editor 50 or a “Personality Editor” used to modify the dynamic data 24b. The host computer 40 may interface directly to the controller 30 using an ethernet connection, serial connection, wireless connection, parallel connection, USB connection or any other applicable connection as is well known to a person skilled in the art. The host computer 40 may be connected to the controller 30 via a network, for example a Local Area Connection connected to the Internet or a mobile phone network. In some instances the host computer 40 may connect directly to the ALD 20 using an ethernet connection, serial connection, wireless connection, parallel connection, USB connection or any other applicable connection. The host computer 40 may be a Personal Computer running Microsoft Windows® operating system or an Apple McIntosh running OS X operating system or almost any other applicable computer system.

The ALD hardware 23 contains electronic circuitry relevant to the ALD type. For example the electronic circuitry for a Tower Mounted Amplifier (TMA) and may contain Field Effect Transistors forming Radio Frequency Low Noise Amplifiers (LNAs) for the frequency of operation. For instance a TMA operating in the cellular “GSM900 band” would be designed to amplify signals in the range 860 MHz-960 MHz (pass band) and to reject frequencies outside this range (stop band).

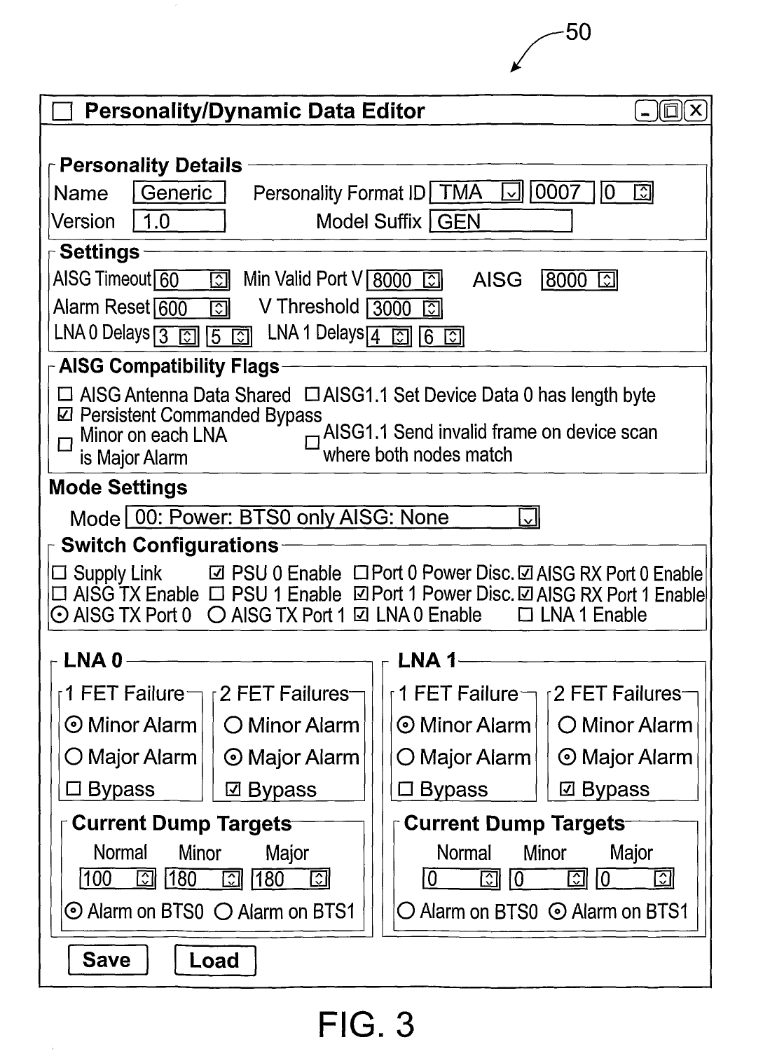

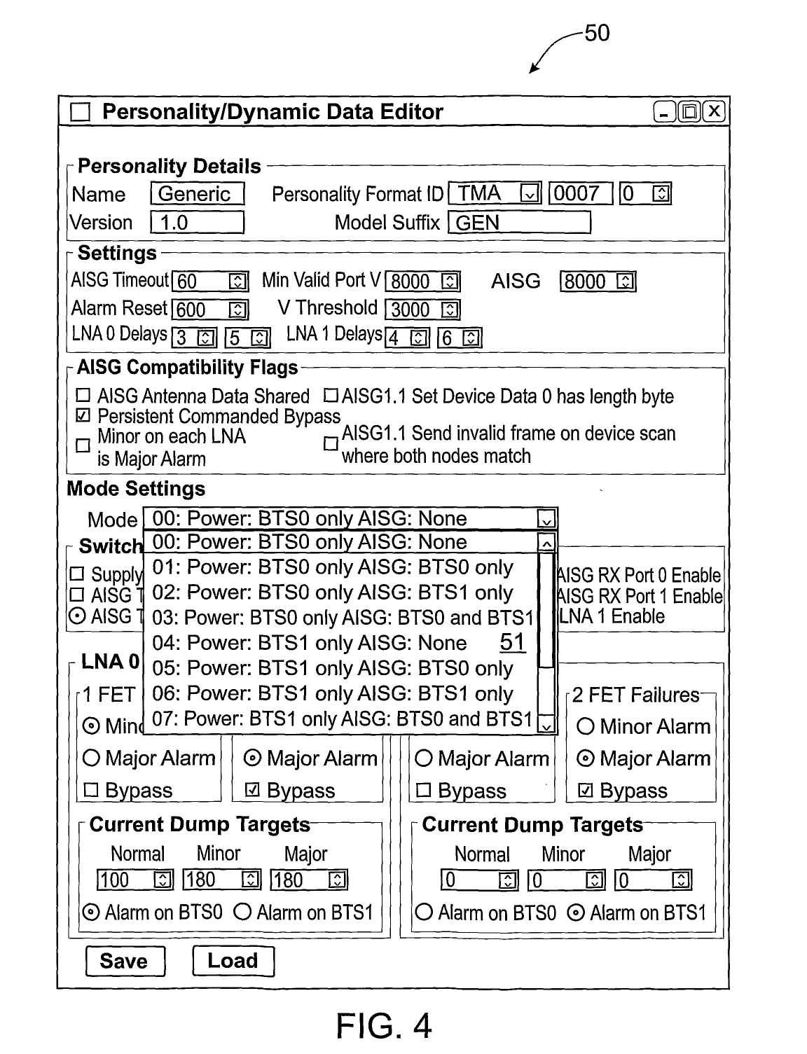

FIGS. 3 and 4 are exemplary screenshots of a user interface of the dynamic data editor 50, installed on the host computer 40 that allows a technician to create or modify dynamic data 24b. The dynamic data 24b may be newly created dynamic data 24b or upgraded dynamic data 24b.

FIG. 3 shows the dynamic data editor 50 used to edit the dynamic data 24b that may contain general settings for:
a) A file name and a version number may be specified and may be reported to the AISG controller as shown in the “Personality Details” section of FIGS. 3 and 4. The file name and version number may be combined with other factory and firmware details and reported in the Hardware or Software version information fields in the AISG “Getinfo” command or other convenient data fields. This allows the technician to determine the full details of the configuration of the ALD using standard AISG controllers.
b) AISG compatibility flags to enable or disable code variations that deal with differing interpretations of the AISG specification by different ALD manufacturers, as shown in a “AISG Compatibility Flags” section of FIGS. 3 and 4.
c) AISG communications timeout to reset the ALD into a current window alarm mode if no AISG data frames are received in a period of time, as shown in a “Settings ” section of FIGS. 3 and 4.
d) Sequencing and timing information initialise the ALD in stages so the current consumption is progressively increased over time rather than a large start up surge to prevent power failure or alarms on different base stations and controllers.

The dynamic data 24b may contain a lookup table of operating modes 51 as shown in FIG. 4. The active operation mode may be selected from the table by the ALD 20 to determine which port or ports are providing power and which port or ports have AISG signals, if any.

The operating modes 51 are read from the lookup table of operating modes and may contain settings for:
a) Hardware switch configurations to place the hardware in the correct operating mode and route power and signals as required for proper operation in the selected mode.
b) Software configuration bits or settings that change based on operating mode. This might include enabling or disabling the AISG communication code or changing communication ports and other behaviors.
c) Settings for current consumption targets of circuits that measure and adjust the current consumption of the ALD using variable loads for both alarm and normal operating states.
d) Settings for current dump switches controlling fixed value loads for both alarm and normal operating states.
e) Alarm Configuration bits for the interpretation of alarms. For instance a Tower Mounted Amplifier (TMA) may have the following alarm configuration bits:

i) Single FET Failure is minor or Major alarm.

ii) Single FET failure causes bypass (shutdown) of LNA.

iii) Dual FET failure is minor or major alarm.

iv) Dual FET failure causes bypass (shutdown) of LNA.

Once the dynamic data 24b has been edited using the dynamic data editor 50 the dynamic data 24b is uploaded to the ALD using the AISG software upload process. The ALD 20 implements two or more distinct targets for the AISG software upload process:

a) Firmware Upload (as defined in the AISG standard).

b) One or more sets of Dynamic Data 24b Upload (the present invention disclosed in this document).

The AISG software upload process does not constrain the format of the data being transferred, but does suggest that a header 24c be included to validate that the data is for the specific ALD to prevent accidental upload of invalid firmware. The present invention defines a header 24c that informs the ALD 20 of the type of data being uploaded either firmware 25 or dynamic data 24b, in addition to ensuring that the data matches the ALD model.

In the preceding example, the dynamic data 24b contained settings for many settings of the ALD. However the dynamic data 24b may be split up into subsets and may define more specific settings of the ALD. For example a first dynamic data 24b file may only contain settings to change receive path gain settings of a Tower Mounted Amplifier (TMA). Furthermore a second dynamic data 24b file may contain settings to change the alarm behavior of a TMA. Additionally, a third dynamic data 24b file may contain settings that define a version of the communication protocol to be used. Each dynamic data 24b file is identified by a unique header and may be uploaded to the TMA individually. The advantage of tailoring a dynamic data 24b file for specific functions of the ALD means that the dynamic data 24b file is much smaller and can be uploaded to the ALD more quickly. A further advantage of splitting the dynamic data is that the same configuration change may be applied to a diverse group of ALDs without affecting the other dynamic data configuration. For example changing the AISG protocol version without affecting alarm behavior.

An upload destination is selected by the ALD and controlled by the header 24c in the dynamic data 24b. A firmware header contains data indicating that the file is to replace the operating firmware whereas a configuration header indicates that the file should be placed into the dynamic data memory. The firmware 25 re-programming process is specific to each processor type and the implementation of the ALD circuitry and is not covered by the present invention.

Space is reserved in the non-volatile memory 24 for two or more dynamic data 24b to be stored. Provision is made within non-volatile memory to indicate which of the dynamic data 24b are currently active. When the ALD 20 accesses the dynamic data 24b, the ALD 20 looks up the active dynamic data and loads the dynamic data 24b.

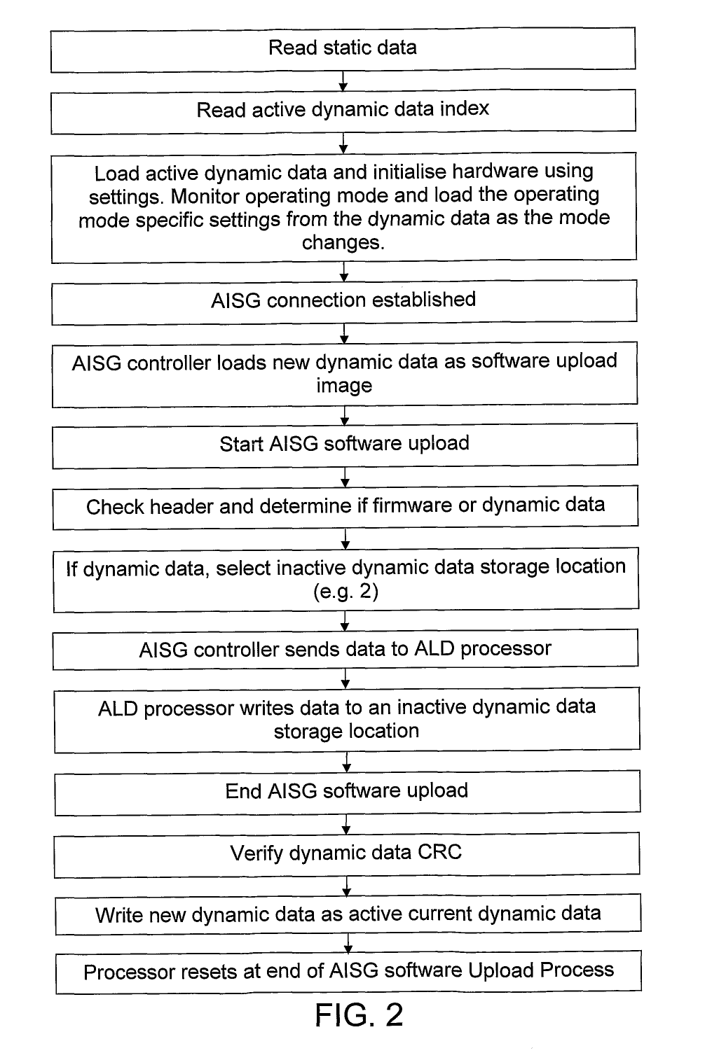

FIG. 2 shows the process to upload the dynamic data 24b to the ALD 20. Firstly, the processor 21 reads which dynamic data set is active, for example dynamic data set 1. The processor 21 loads the active dynamic data 24b and initialises hardware settings for upload. The processor monitors the operating mode and loads the operating mode settings from the dynamic data as the mode changes. Next the processor establishes the AISG connection with the controller 30 and the controller 30 loads the dynamic data 24b as a software upload image as is known to a person skilled in the art. The AISG software upload process is then started by the controller 30. The processor 21 then checks the header 24c of the dynamic data 24b to determine if the data is firmware 25 or dynamic data 24b. If the data is dynamic data 24b the processor 21 selects an inactive dynamic data location in non-volatile memory 24 (for example location 2). Next the controller 30 sends the dynamic data 24b to the processor 21 and the processor 21 writes the dynamic data 24b to the inactive dynamic data location completing the AISG software upload process. The processor subsequently verifies the dynamic data 24b using a Cyclic Redundancy Check or any other error detection mechanism such as a Hash function or cryptographic Message Authentication Code. The new dynamic data location is then selected as the active dynamic data 24b if successfully verified. The final step is for the processor 21 to reset and read the active dynamic data 24b.

Using this process, the firmware 25 is not modified by the dynamic data modification so a single version of firmware 25 can be uploaded into all configurations of the ALD.

Other configuration parameters can be set depending on the type of ALD 20 being configured without detracting from the scope of this invention.

The present invention provides many advantages and benefits for both customers and manufacturers of ALDs including:
1) Customers may stock a single model of ALD for spares and new installations, reducing inventory costs and simplifying the management of firmware upgrades and maintenance operations.
2) Customers may configure the base station or modify the installation with out having to replace the ALD, greatly simplifying the upgrade process and thus reducing costs.
3) Base station configurations (set by dynamic data) may be modified substantially in real time to improve coverage even when the ALD 20 is in use.
4) The dynamic data editor software tool can be used by customers to define and edit the dynamic data 24b, making it easy to perform changes to the behavior of the ALD to meet customer requirements. The software tool can produce the dynamic data ready for upload. The dynamic data may also be managed separately from the firmware source code.
5) ALD customers do not need to know the precise specifications of all their base stations and installation configurations when procuring ALDs, as the ALD 20 can be configured using the dynamic data editor software tool.
6) Only a single version of ALD firmware 25 needs to be written, maintained, debugged and programmed for each ALD 20. This saves significant software engineering time for the ALD manufacturer.
7) As there is a single version of ALD firmware 25, manufacturing processes are greatly simplified and streamlined and reducing inventory and production costs.
8) Should a new feature be required in the ALD firmware 25 or a bug is reported, only one new firmware 25 needs to be written, tested and released to all customers for uploading to ALDs 20 in the field. The firmware upload will not affect the current dynamic data and so no special configuration management tasks are required when deploying the firmware update to the ALDs 20.
9) Only a small number of product models need to be offered to customers by the ALD manufacturer to support a wide range of base stations and installation configurations reducing ALD manufacturer and customer inventories.

Other embodiments, using the present invention may be apparent to transfer dynamic data 24b to different types of communications device, for example the communications device may be VSWR measuring equipment. The process of creating and uploading the dynamic data 24b will be identical to the embodiment previously described, however the fields within the dynamic data may differ.

The above description of an embodiment of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A communications device comprising:
firmware storing instructions for controlling a processor to operate communications hardware according to a configuration;
memory storage containing static data and at least one set of dynamic data defining the configuration, the dynamic data being dynamically upgradeable to change the configuration of the communications device substantially in real time.

2. The communications device of claim 1 wherein the dynamic data is upgraded dynamic data or newly created dynamic data.

3. The communications device of claim 1, wherein the static data and dynamic data are stored in non-volatile memory.

4. The communications device of claim 1 wherein the communications device is an Antenna Line Device.

5. The communications device of claim 4 wherein the Antenna Line Device is defined by the Antenna Interface Standards Group (AISG)/3rd Generation Partnership Project (3GPP) standard.

6. The communications device of claim 1 wherein the instructions stored in the firmware are suitably configured to cause the communications device to:
receive upgraded dynamic data via a communication interface;
write the upgraded dynamic data to an inactive area of the memory storage; and
select the upgraded dynamic data as active dynamic data.

7. The communications device of claim 1 wherein the dynamic data sets any one of failure modes, a communications channel or hardware to bypass the communications device.

8. The communications device of claim 1 wherein the dynamic data sets alarm thresholds.

9. The communications device of claim 1 wherein a communications protocol is used to transmit the dynamic data is an AISG/3GPP protocol.

10. The communications device of claim 1 wherein the dynamic data configures the hardware to initialise in stages.

11. The communications device of claim 1 wherein the dynamic data contains a header.

12. The communications device of claim 1 wherein the dynamic data defines a subset of a configuration.

13. The communications device of claim 1 wherein the dynamic data defines a version of the communications protocol to be used.

14. A method for configuring a communications device comprising firmware storing instructions for controlling a processor to operate communications hardware and memory storage containing static data and at least one set of dynamic data defining a configuration; the method including steps of:
creating dynamic data at a host computer; and
transmitting the dynamic data from the host computer to the communications device via a communications interface substantially in real time.

15. A method of configuring a communication device of the type comprising firmware storing instructions for controlling a processor to operate communications hardware to a configuration and memory storage containing static data and at least one set of dynamic data defining the configuration; the method including the steps of:
receiving dynamic data via a communication interface;
writing the dynamic data to an inactive area of the memory storage in the communication device; and
selecting the dynamic data as active data.

16. The method of claim 14 or 15 wherein the dynamic data is upgraded dynamic data or newly created dynamic data.

17. The method of claim 14 or 15 the static data and dynamic data are stored in non-volatile memory.

18. The method of claim 14 or 15 wherein the communications device is defined by the AISG/3GPP standard.

19. The method of claim 14 or 15 wherein the instructions stored in the firmware are suitably configured to cause the communications device to:
receive upgraded dynamic data via a communication interface;
write the upgraded dynamic data to an inactive area of the memory storage; and
select the upgraded dynamic data as active dynamic data.

20. The method of claim 14 or 15 wherein the dynamic data sets any one of failure modes, a communications channel or hardware to bypass the communications device.

21. The method of claim 14 or 15 wherein the dynamic data sets alarm thresholds.

22. The method of claim 14 or 15 wherein a communications protocol used to transmit the dynamic data is an AISG/3GPP protocol.

23. The method of claim 14 or 15 wherein the dynamic data configures the hardware to initialise in stages.

24. The method of claims 14 or 15 wherein the dynamic data defines a version of the communications protocol to be used.
